(19) United States
(12) Patent Application Publication
(10) Pub. No.: US 2025/0288910 A1
(43) Pub. Date: Sep. 18, 2025

(54) INFORMATION ACCESS MANAGEMENT SYSTEM AND METHOD

(71) Applicant: Sony Interactive Entertainment Inc., Tokyo (JP)

(72) Inventors: Daniel Israel Pereira Jimenez, London (GB); Christopher Henderson, London (GB); Timothy Bradley, London (GB)

(73) Assignee: Sony Interactive Entertainment Inc., Tokyo (JP)

(21) Appl. No.: 19/068,732

(22) Filed: Mar. 3, 2025

(30) Foreign Application Priority Data
Mar. 12, 2024 (GB) 2403535.4

(51) Int. Cl. A63F 13/67; A63F 13/65

(52) U.S. Cl. CPC A63F 13/67; A63F 13/65

(57) ABSTRACT

A system for performing a selective data access for a character in a virtual environment, the system comprising a data structure identification unit configured to identify a data structure to be accessed, the data structure comprising data regarding the virtual environment in which the character is present and/or one or more skills which are able to be utilized by that character, a parameter identification unit configured to identify one or more parameters associated with the character, and a data access unit configured to access one or more portions of the data structure in dependence upon the identified parameters, wherein the one or more portions correspond to at least one of a plurality of available levels of detail within the data structure.

### BACKGROUND OF THE INVENTION

### Field of the Invention

This disclosure relates to an information management system and method.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Interactive content, such as video games, often includes a number of non-player characters (NPCs) which are provided to enrich the user experience—these can be characters which provide a function within a virtual environment, such as a shopkeeper or a quest-giver, or those which simply add flavor and/or variety to the user experience through non-functional interactions (that is, interactions which do not have a gameplay effect). In some games, the number can be rather limited—but as games increase in scale the number of NPCs can number into the hundreds or even thousands.

While an increase in the number of NPCs can be advantageous in that it can increase the level of variety and interactivity able to be provided to a player, there are a number of possible associated drawbacks. These are often associated with the desire that each NPC should be unique, or at least sufficiently differentiated that the user does not feel that they are interacting with the same character whenever they interact with an NPC. This can lead to a significant burden upon the content creator in developing a large number of NPCs having respective ‘personalities’ (that is, appearing to be different characters), as well as a storage burden in storing the information representing these NPCs in memory.

In some cases, NPC behavior may be scripted by a content creator so as to cause an NPC to behave in a particular way. This places an additional burden upon the content creator, as well as increased the storage burden through requiring such scripting to be stored. Scripting can also lead to an NPC acting ‘out of character’ if the scripting is not performed to a high standard; this can mean that a content creator is compelled to spend a lot of time ensuring that that the scripting is sufficiently appropriate and detailed.

It is in the context of the above discussion that the present disclosure arises.

### BRIEF SUMMARY OF THE INVENTION

This disclosure is defined by claim 1. Further respective aspects and features of the disclosure are defined in the appended claims.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment system;

FIG. 2 schematically illustrates an exemplary data structure;

FIG. 3 schematically illustrates an alternative hierarchical data structure;

FIG. 4 schematically illustrates a method by which a character accesses a data structure such as those shown in FIGS. 2 and 3;

FIG. 5 schematically illustrates a system for performing a selective data access; and

FIG. 6 schematically illustrates a method for performing a selective data access.

### DETAILED DESCRIPTION OF THE INVENTION

Referring now to the drawings, wherein like reference numerals designate identical or corresponding parts throughout the several views, embodiments of the present disclosure are described.

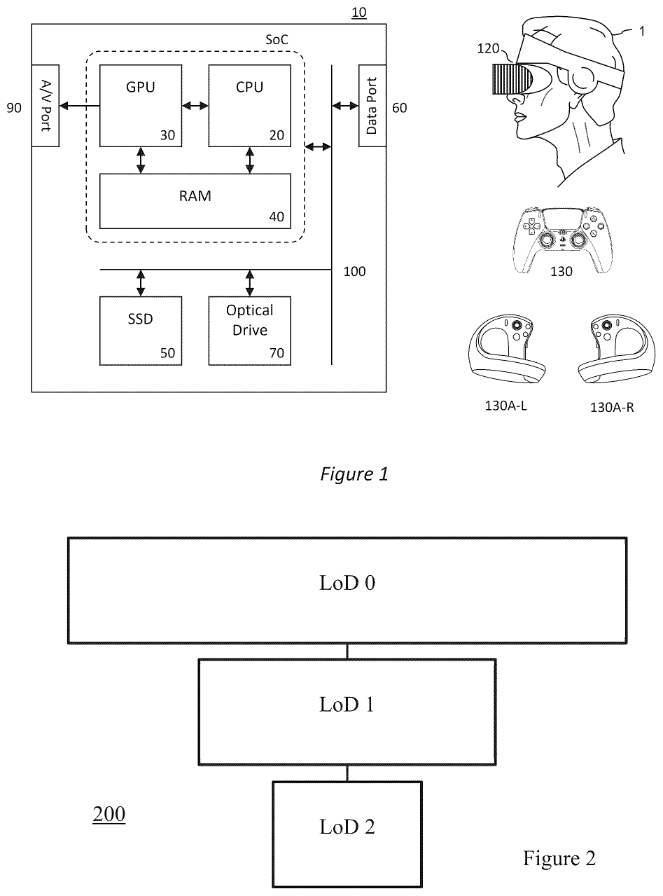

Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid-state drive, or an internal solid-state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD.

Embodiments of the present disclosure provide an efficient manner of providing NPCs within a virtual environment, with efficiency benefits being realized in both the creation of the NPCs and the storage of relevant data. Further benefits can be observed in that character knowledge or skill (for instance) can be accessed on a per-item basis—it is not necessary to load all of the information defining a character's traits (as would usually be the case in the art), as only those of relevance to a given interaction would be loaded in detail. The perceived level of realism associated with each of the NPCs can also be improved, by virtue of a more consistent and natural approach to NPC knowledge and skills. In addition to this, updates to character information can be managed centrally (rather than requiring an update of each character's profile) due to being able to modify a central data structure which is referenced by those characters. This provides an efficient and consistent method for data management.

FIG. 2 schematically illustrates an exemplary data structure 200 which may be referenced during interactions with a virtual environment by a player. Each of the three components of the data structure (LoD 0, LoD 1, LoD 2) corresponds to a different level of detail (LoD) of information (for example). While the term level of detail, LoD, is used in this description it is considered that this term is not limited specifically to levels of ‘detail’. For example, a higher LoD may comprise additional information which expands the scope of the information rather than increasing the level of detail−in other words, while level of detail may typically be taken to refer to the depth of information about a topic, it can also be taken to mean breadth of information in the context of the present disclosure.

Such a data structure may be defined on any suitable basis; in some cases, this can be per-item/-action, while in others the data structure may represent a group of items/actions, or a topic/action as a whole. For instance, respectively these could relate to a specific animal, a family of related animals, or all (or at least a range of) animals; or fighting with swords, fighting with melee weapons, or fighting more generally. Such a correspondence between data structures and the information/skills represented may be selected freely for a given implementation, and can vary within a given group of data structures—for instance, a game may be associated with some very specific data structures as well as some broader ones (for example, one relating to the location of pubs in a village and one relating to information about every animal in the game). In some cases, the content within different respective data structures may overlap—a data structure with information about birds and one with information about animals may both include an identification of a common or well-recognized bird such as a magpie.

The relative sizes of the LoD components in FIG. 2 reflect the amount of information that each component comprises—although of course the sizes shown here are entirely exemplary. It is also considered that the number of components can be selected freely, rather than being limited to three as shown in this Figure. The data structure 200 may be comprised within a single file in which data is accessed on a selective basis; alternatively, the data structure may be comprised within a plurality of files corresponding to different LoDs on any suitable basis (such as a one-to-one or many-to-one basis).

The first component, LoD 0, represents a broad but basic knowledge of a topic-with the second and third components, LoDs 1 and 2, representing increasingly detailed information (albeit in smaller quantities). In this case, the higher-numbered components (LoDs 1 and 2) are considered to also encompass the information comprised in the lower-numbered components. For instance, data access on the basis of LoD 1 is also considered to provide access to LoD 0, such that the access provides all of the information comprised in each of these two components.

While in some cases the components may be standalone sources of information that can be referenced separately, it is also considered that the higher-numbered components act as refinements to the lower-numbered components. For instance, the higher-numbered components may fill in gaps in lower-numbered components (representing a broadening of knowledge) or correct entries (so as to represent increased knowledge dispelling a beginner's misconceptions, for example).

While shown here in a hierarchical structure in which data is read from one or more components in combination where appropriate, it is also considered that the components are entirely standalone—such that LoD 1 comprises all of the information of LoD 0. While this can increase the amount of data that is stored, as the most basic information may be duplicated several times, this may improve access times as a single data component is able to be referenced rather than multiple.

Rather than being limited only to reference information, such a structure may also be used to include information which dictates skills within the virtual environment or any other hierarchical quality or quantity. In such a case, the higher-numbered LoDs can be taken to comprise information enabling a more skilled application of the same skill or skills (depth) and/or the ability to perform additional related skills (breadth).

Access to a particular component of a data structure such as the one illustrated can be granted in dependence upon characteristics associated with an NPC or other character in a virtual environment (such as a player character). These characteristics are representative of the NPCs knowledge or experience in a field or skill which corresponds to the data structure in question, so as to qualify that character's access of a particular level of information or skill.

In some cases, the mapping may be direct (such as a characteristic which specifies a data structure and a highest LoD—for instance, ‘ornithology—level 3’) or may be inferred from characteristics which describe the NPC. For example, if an NPC has a background indicating an interest in birds and ownership of a pair of binoculars, but no formal training on the subject and a limited number of years of experience (for instance, based upon age of the NPC) they may be assigned a level of 3 (out of, say, 5) when accessing a data structure representing ornithology.

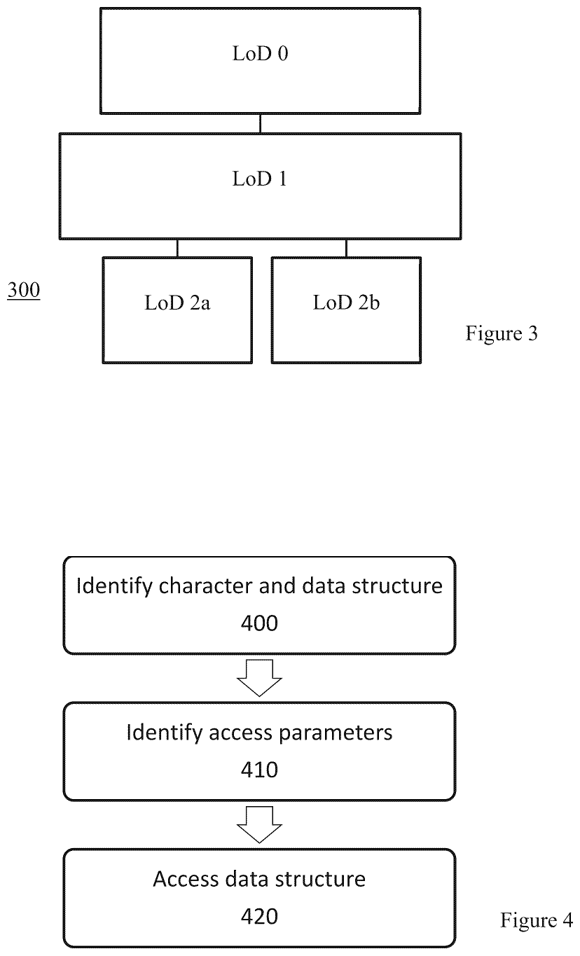

FIG. 3 schematically illustrates an alternative hierarchical data structure that may be employed, so as to show that the structure may be modified as appropriate for a given set of information or the like. In this case, the data structure 300 comprises a first component (LoD 0) which represents a reduced amount of information relative to the second component (LoD 1). This is a reversal of the relative amount of information in these respective structures as shown in FIG. 2, representing a much smaller amount of information at the lowest level and an increased amount of information at the first level.

A further modification to the data structure 200 of FIG. 2 represented by the data structure 300 of FIG. 3 is that of having two diverging LoDs at level 2 (that is, LoD 2a and LoD 2b). This represents diverging knowledge on a subject for instance-this can be a method of representing specialisms within a topic (such as the data structure representing ‘physics’ and the diverging LoDs representing ‘quantum physics’ and ‘astrophysics’) for example, or may represent different sources of relevant knowledge or experience leading to the gathering of relevant knowledge (such as ‘practical’ versus ‘book-learning’, or ‘grew up in a city’ versus ‘grew up in a village’). Of course, these may overlap to some degree, and the number of diverging LoDs can be set at any suitable value. A single character may be able to access any number of these diverging LoDs—while some may be able to access none or one, others may be able to access several or all of them should the characteristics of that character support such competency.

In some cases, the branching may lead to a skewed hierarchical structure-for instance, in the example of FIG. 3 LoD 2a may be the highest-numbered LoD in that branch, while LoD 2b may lead to further LoDs such as an LoD 3 and an LoD 4. In other words, any suitable format of the structure may be utilized in dependence upon the information being represented by the structure.

FIG. 4 schematically illustrates a method by which a character accesses a data structure such as those shown in FIGS. 2 and 3. Reference to a character accessing a data structure is a simplification in this context to aid clarity, as it is instead considered that a process (such as a video game or a component thereof) accesses the data structure as a part of the rendering of the character's interactions.

A step 400 comprises identifying a character and a data structure; in particular, the character is one that is rendered as a part of a virtual environment or the like-and as such is able to be interacted with by a user. In some cases, the identification may be performed in response to an interaction with the user (or a character associated with the user), while in other cases the rendering of the character in a particular setting or scenario is sufficient to trigger an identification.

Identification of the character includes both determining the identity of the character and determining one or more characteristics of the character which relate to a given scenario or interaction. Similarly, a data structure is identified on the basis of a given scenario or interaction. In some cases, a particular scenario or interaction may be linked to given characteristics in a predetermined fashion, while in others a contextual analysis (for instance, using a machine vision process or a game state analysis) may be performed to determine relevant characteristics.

For example, if a character is engaged by an enemy (and therefore a game state of ‘in combat’ may be triggered) then a characteristic of ‘combat skill’ may be identified. In accordance with this, a character's proficiency or knowledge is identified from an associated profile and a corresponding data structure (which comprises information dictating how the character will act in combat) will be identified. This is an example of a data structure being identified on the basis of an interaction (that is, the engagement).

Similarly, if a character enters a farm, then characteristics associated with farms, animals, nature, or any other contextually-suitable characteristics may be identified—and corresponding data structures may be identified. This is an example of a data structure being identified on the basis of environmental context (that is, an identification of the location of the character).

It is also considered that an identification may be performed on the basis of both an interaction and the location of the character. For instance, if a character enters a woodland and begins to cook mushrooms on a campfire the associated data structures may be ‘cooking’ (based on the interaction), ‘woodland knowledge’ (based on the location), and ‘mycology’ (based on items being used in the interaction). These complementary data structures can therefore represent a user's proficiency and knowledge relating to this scenario in a flexible and effective manner.

In some cases, there may not be a direct mapping between a character's characteristics and the data structures—in such cases, any suitable approach to interpretation may be taken. For instance, a textual analysis may be performed to identify a correspondence (such as identifying data structure tags with a semantically similar tag to characteristic), or a predetermined mapping may be consulted. In some cases, a machine learning model may be provided which is configured to identify a correspondence—this may be trained based upon data which pairs scenario information and correctly-identified data structures, for example.

A step 410 comprises identifying access parameters for the data structure; in other words, determining which level of detail is to be accessed for the identified character. As described above, this may be on the basis of a numerical value (or an equivalent) which indicates a specific level of detail to be accessed for a given characteristic. Alternatively, or in addition, information about the character may be used to derive a suitable access parameter—a narrative description of a character's backstory may be used to select an access parameter (or modify an existing parameter), for example, and/or a log of events experienced by that character.

The identification of access parameters may also comprise determining the location of information that is to be accessed. For instance, determining the location of a specific file and/or portion of a file that is to be accessed. In other words, once a particular level of detail is identified this step may further comprise identifying a storage location associated with that level of detail.

A step 420 comprises accessing the data structure on the basis of the access parameters identified in step 410. This step may further comprise any use of the data as appropriate in generating interactions or the like within a virtual environment for the character; for instance, the accessed data may be used to select a specific action that is performed by the character or to determine words spoken by the character.

This access may be managed in any suitable manner which enables the access parameters to be used to determine a specific file or portion of a file to be read. For instance, a look-up table which maps a topic/LoD to a particular file location may be used; alternatively, a directory may be provided which comprises a number of pointers, each corresponding to a given topic/LoD, to a respective file or portion thereof. In some cases, an application (such as a game) may comprise an algorithm, standardized file naming convention, and/or other information which enables the file/portion of a file to be accessed directly.

Further functions may also be performed in conjunction with the accessing of the data structure—for instance, access statistics may be maintained for a character's accesses of respective data structures. This may be a number of accesses on behalf of that character, for instance, or a record of the most recent access by that character. Such information may be stored by the data structure, in an associated metadata file, or as a part of the character data, for example. Other functions that may be performed include updated a correspondence between a data structure and an identified scenario or the like—for instance, if a data structure is identified but the data is not used then it may be appropriate to indicate that there is no correspondence between the data structure and the scenario so as to avoid identification of the data structure on future occurrences of that scenario.

A number of exemplary modifications and variations upon the above method are described below; these are not regarded as limiting, rather they are considered to demonstrate that the approach described in this document is flexible in dependence upon the specific implementation details.

As discussed above, the format in which the data to be accessed is provided can vary in accordance with the implementation details for a specific arrangement.

In some cases, a single data structure comprising all the information which can be accessed by characters is provided—this may be segmented in any suitable manner, for instance with a character being able to access particular parts of a single file, or the structure comprising a number of different elements such as in a hierarchical data structure. In the case that a single hierarchical data structure is provided, each of the branches from a top of the hierarchy may correspond to a different topic/skill, so as to aid navigation of the data structure.

Alternatively, a plurality of hierarchical data structures may be provided, or a plurality of files which each offer conditional access to specific portions of the respective files. These may in some cases be provided in conjunction with a single reference file which identifies locations for the files or portions of the files, such as a look-up table or a set of pointers.

A number of variations to the access of data may be considered as part of a specific implementation of the process disclosed in this document.

A first example of this is in the case that an algorithm is provided to determine access parameters from a range of character attributes/characteristics. This can enable a more flexible approach to the access of data structures, as the correspondence between the data structure and the characteristics need not be one-to-one. This can also reduce the storage requirements for storing information about a character, as it allows access parameters to be derived rather than explicitly stored.

An algorithm may identify any number of contributory factors for a particular topic or skill as appropriate. For instance, rather than defining a character's skills at a range of different activities, an algorithm could be used to generate an appropriate skill level for a user based upon skills that have been defined and/or other information. For instance, rather than a character having a defined skill level for ‘juggling’, an algorithm may identify suitable information that is defined for the character (for instance, based upon information associated with the skill ‘juggling’ which indicates the nature of the skill) which could include dexterity, throwing skill, coordination, and whether the character history indicates they likely have relevant experience (such as a backstory of being in a circus).

Similarly, in the case of knowledge (rather than skills), an example is that of the topic being ‘cake recipes’; contributing factors may be whether a character has baked cakes before, whether their social network includes bakers, and whether they have attended baking classes or watched baking television shows. Many of these factors may be found in a character's backstory, rather than in attributes, or in their context within a virtual environment—the context including factors such as a geographical location, a profession, a social network, and the contents of their inventory.

The algorithm may be defined as a part of the content in which the character appears, such as created by the developer of a game. Alternatively, if the data structures are defined externally to the content, the algorithm may be defined by the creator of the data structures. A further alternative is that of the algorithms being defined as a standard which is used by multiple pieces of content—with the inputs and the referenced data structures able to be varied freely with the content.

Rather than a manual definition of an algorithm, a machine learning model may be trained to identify access parameters. For instance, a generative adversarial network (GAN) may be used in which a training dataset comprises a number of characters with defined backstories/contexts/attributes and a manually-defined LoD or skill level for particular data structures as appropriate. Other approaches to the training may also be considered as appropriate, with the training intended to develop a model into which character details can be input and an appropriate set of LoDs or skill levels obtained.

Rather than a skill level or LoD being a static quantity for a given character, it is considered that these may be dynamic in response to a number of different factors. These different factors may be considered alone or in combination to determine appropriate access parameters. The use of dynamic quantities may lead to a more realistic virtual environment and/or character(s), as it would (for example) be expected that over time characters become more knowledgeable or pick up new skills in their day-to-day life.

One such factor is the gaining of experience by a character. For instance, if a character attends a class, practices a skill, or otherwise undertakes an activity that is expected to increase their knowledge of a topic or a level of skill, this should lead to a change in the access parameters. These changes can be reflected in an activity log associated with a character (which can be consulted as a part of the access parameter identification process), for example, or can directly change underlying attributes of a character. While not every such activity will increase the identified LoD or the like, completing a number would be expected to do so. In view of this, activities may be assigned a weighting or the like to indicate their impact on the character's competence or knowledge.

Another source of dynamism in a skill level or LoD is that of interactions with other characters; this can be identified from a character's social network or the like which may be stored as information associated with a character. Characters which are close friends with characters having particular skills (such as being friends with a baker, as referenced above) may be considered to have a higher competency in those skills as it is likely that they will have picked up some tips or knowledge to aid their competency. This can enable a more realistic virtual environment, as a group of characters will have a more realistic distribution of knowledge/skills in which many people have at least base competency through their interactions with those who are more knowledgeable/skilled.

While these examples demonstrate that the dynamic approach to LoD determination/skill levels can be advantageous in reflecting growth of a character or more natural interactions with other characters, it is also considered that characters may lose skills or knowledge and that this may be reflected through a reduced skill level or LoD determination. For instance, a character may become ‘rusty’ if they do not regularly practice a skill or may forget details on a topic if they do not regularly utilize information.

This can be simulated in considering the frequency of access to a particular data structure for a character, or at least an indication of how long (either real time or in-game/-environment time) has elapsed since the last access. Should the access not be recent or frequent enough (compared to threshold values which are defined on a per-character, per-content, and/or per-data-structure basis) then the identified LoD or skill level should be reduced to reflect this. The amount of the reduction may be determined freely by the skilled person to correspond to a desired level of penalty for not using skills/knowledge on a regular basis.

While in some cases a specific LoD for access may be indicated as a character attribute, in some cases a skill level may be stored which can be mapped to a given LoD using an algorithm or the like. For instance, a value from 0-99 (or indeed, any range) may be stored which is indicative of experience, skill, or knowledge in a corresponding area. This can be converted to an LoD in a linear manner (such as 0-49 corresponding to LoD 0 and 50-99 corresponding to LoD 1), for example, or a more complex algorithm may be used to map these skill levels to LoDs. The latter approach may be more suitable when numerous attributes are used to determine a suitable LoD; in such a case, the total values of the skill levels may be summed (directly or with a weighting) or another operation (such as multiplication, or more complex calculations) applied so as to generate a single representative value for mapping to a suitable LoD.

While in many cases a character is granted to an LoD of a data structure in a straightforward manner, in some cases it may be desirable to adopt a more varied approach in which partial or mixed-level access is possible. For instance, a character may be granted access to half of the information comprised within a given LoD or any other sized portion. Portions of an LoD may be predefined or may be selected randomly. In some cases, an LoD may be notionally divided into a plurality of segments with one or more of these being selected on a random or other basis in dependence upon an input. This can enable a greater variety in knowledge/skill between characters with a similar level of knowledge or aptitude, enriching a corresponding virtual environment and further increasing the amount of character diversity that can be supported in an efficient manner.

For instance, a character may have their access level for a data structure defined (or identified) as LoD 1.5; in this case, the character may be able to access all of the data in LoD 0 (in the case that this comprises information not found in LoD 1) and half of the data in LoD 1. This may be the first/second half of the data file based upon storage space (reading a file sequentially, for instance), half the predefined portions of data within LoD 1, or half of the entries within LoD 1 (such as data fields).

Mixing of levels may also be used to provide a similar effect. This may be implemented in a number of suitable manners; for instance, a character may be assigned an access level for each LoD that is available within a data structure—such as LoD 0 [1], LoD 1 [0.5], LoD 2 [0.1]. Such parameters could be taken to indicate that the character is able to access all information in LoD 0, half the information in LoD 1, and ten percent of the information in LoD 2. The access of this information can be implemented in the same manner as the partial levels as has already been described.

Without additional constraints it may be possible (depending on the skill/topic) that inconsistencies arise when mixing information from different LoDs in the same data structure—for instance, a character may (as a result of such mixing of LoD access) be able to run before they are able to walk, or may be able to discuss the geography of a town in a given region whilst not knowing that the region itself exists. Such issues can be avoided by introducing dependencies between portions of different LoDs; for instance, requiring that a certain portion of LoD 1 is able to be accessed before a corresponding portion of LoD 2 is able to be accessed.

To provide an example, if LoD 2 comprised information about the layout of a particular town then access of this data may be made contingent upon access of data in LoD 1 which indicates the existence of that town. This may be implemented by the portion of information in LoD 2 referencing the portion of LoD 1, for example, or data associated with the LoD may be provided which describes such dependencies.

Should such dependency data be made available, a subset of LoD 2 may be identified as being suitable candidates for access in dependence upon the information which has been accessed by a character in LoD 1. For instance, the accessed data in LoD 1 may be put into an algorithm or compared to a look-up table so as to identify allowable portions of LoD 2 for access to ensure that information/skill consistency is maintained for a character.

While the above description has referred largely to non-player characters, similar approaches to data/skill management may be applied for player characters. This may be useful for enabling more responsive and appropriate dialogue for a user within a game, for example, as the character's knowledge may be reflected accurately in a conversation without the use of extensive scripting as would otherwise be the case for representing a wide range of eventualities corresponding to different player circumstances.

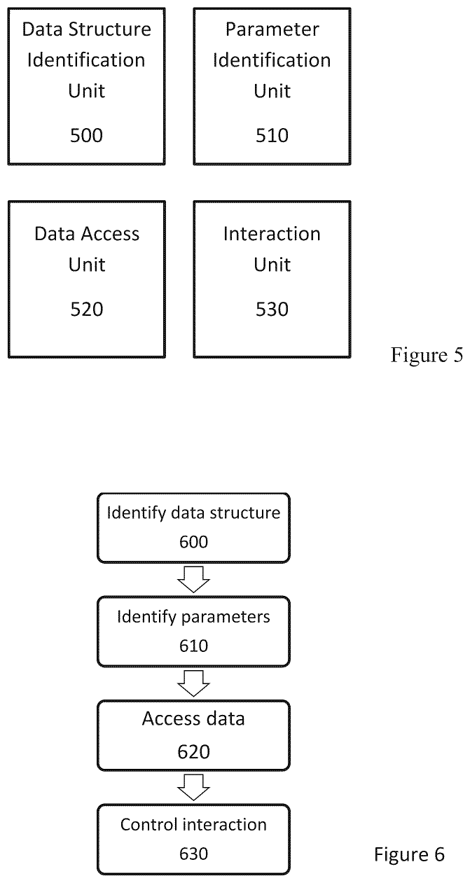

FIG. 5 schematically illustrates a system for performing a selective data access for a character in a virtual environment, the system comprising a data structure identification unit 500, a parameter identification unit 510, a data access unit 520, and an optional interaction unit 530. The data access is performed on a data structure comprising data regarding the virtual environment in which the character is present and/or one or more skills which are able to be utilized by that character.

The data structure identification unit 500 is configured to identify a data structure to be accessed. This may be performed in dependence upon any suitable parameters; for example, the data structure identification unit may receive an input which indicates a particular data structure to be accessed. For instance, a game may use a game state to generate a request for information from a particular data structure for that character. Alternatively, or in addition, one or more inputs (such as a game state, or a current interaction being undertaken by the character) may be provided to the data structure identification unit 500 to enable an identification to be performed.

The data structure may be configured in any suitable format for a given implementation; examples of this are described above. In some implementations, the data structure comprises a hierarchical arrangement of data configured such that each hierarchical level corresponds to a different level of detail within the data structure—such a configuration is exemplified by FIGS. 2 and 3, for example. Any suitable arrangement of related data may be considered as a data structure in the present context; a single file comprising a number of different portions, or a plurality of files, each able to be referenced individually are considered suitable, for instance.

One or more portions of the data structure may respectively correspond to data of an entire level of detail (as shown in FIG. 2); alternatively, or in addition, one or more portions of the data structure may respectively correspond to a subset of the data for a given level of detail. An exemplary data structure which shows both of these approaches is shown in FIG. 3. Information associated with the data structure may be used to indicate one or more dependencies between portions of the data comprised by the data structure; this information may be associated metadata, for example, or information comprised within the data structure itself.

The parameter identification unit 510 is configured to identify one or more parameters associated with the character. The parameters associated with a character may include one or more of text descriptions, an event or action log, skill levels, accessible levels of detail for the data structure, and/or information indicating a history of access to the data structure by that character. The parameters may be stored as a part of a character's profile within the virtual environment or a game comprising the virtual environment, for example. In some implementations, such parameters may be inferred or calculated from information stored as a part of a character's profile—for instance, based upon skill levels that are defined in a profile a skill level may be defined for a further skill based upon expectations about transferable knowledge/competency.

The data access unit 520 is configured to access (that is, read data from) one or more portions of the data structure in dependence upon the identified parameters, wherein the one or more portions correspond to at least one of a plurality of available levels of detail within the data structure. This data access may include accessing data from levels of detail on any suitable basis; one or more entire levels of detail may be accessed and/or one or more partial levels (or partial accesses of levels) may be accessed. In some cases, the data access unit 520 may be configured to access two or more portions of the data structure which together correspond to a subset of data for each of two or more respective levels of detail; in other words, part of each of a first and second level of detail may be accessed in combination in addition to (or instead of) an entire level of detail.

The data access unit 520 may be configured to input the one or more parameters into an algorithm to determine one or more access parameters; these access parameters can be used instead of the identified parameters to access the data structure. This may be appropriate in cases in which the parameters are not specific levels of detail (or direct indicators thereof), for example, or when multiple parameters are to be used to identify an access parameter for a particular data structure.

In some cases, the data access unit 520 may be configured to incorporate a random element into the data access for a character such that identical identified parameters correspond to non-identical data accesses. This may be particularly advantageous when a data access corresponds to a portion of a level of detail, as it can enable different characters to access different portions despite having the same parameters. This can therefore add variety to the knowledge of a group of similar characters. This random element may be introduced when determining which portions of a level of detail to access, for instance.

Optionally, the data access unit 520 is configured to store data describing the accessed portions of the data structure for a character; this data can be used for future data accesses of that data structure by that character. This record of accesses can be used to indicate a number, frequency, or recency of accesses by a character for a particular data structure (for example), and/or to indicate which portions are accessed for the purpose of continuity (that is, to ensure that a given character has a consistent knowledge rather than it changing with each access).

The interaction unit 530 is an optional unit which is configured to control an interaction between the character and another element (such as another character or an object) within the virtual environment in dependence upon the data access. In other words, the data obtained as a part of the data access is used to select an action taken by the character or to otherwise modify an interaction.

For example, the interaction may a conversation between the character and a player character associated with the player of a game comprising the virtual environment; in such a case, the lines spoken by the character may be selected or generated in dependence upon the data access. It is also considered that more general interactions fall within this scope, such as a character deciding upon a course for navigation based upon the data access—in this case, the element may be considered to be the virtual environment itself, or the target of the navigation (with the interaction being moving towards it).

The arrangement of FIG. 5 is an example of a processor (for example, a GPU and/or CPU located in a games console or any other computing device) that is operable to perform a selective data access for a character in a virtual environment, and in particular is operable to:
identify a data structure to be accessed, the data structure comprising data regarding the virtual environment in which the character is present and/or one or more skills which are able to be utilized by that character;
identify one or more parameters associated with the character;
   access one or more portions of the data structure in dependence upon the identified parameters, wherein the one or more portions correspond to at least one of a plurality of available levels of detail within the data structure; and, optionally
   control an interaction between the character and another element within the virtual environment in dependence upon the data access.

The processor described here may be implemented as the CPU 20 or GPU 30 of FIG. 1, for example, or any other suitable processing means located in a hardware device. The functionality described may be implemented by a number of such processors in combination, rather than being required to be implemented by a single processor.

FIG. 6 schematically illustrates a method for performing a selective data access for a character in a virtual environment. This method may be implemented in accordance with the discussion of the system of FIG. 5, for example.

A step 600 comprises identifying a data structure to be accessed, the data structure comprising data regarding the virtual environment in which the character is present and/or one or more skills which are able to be utilized by that character.

A step 610 comprises identifying one or more parameters associated with the character, such as one or more of text descriptions, an event or action log, skill levels, accessible levels of detail for the data structure, and/or information indicating a history of access to the data structure by that character.

A step 620 comprises accessing one or more portions of the data structure in dependence upon the identified parameters, wherein the one or more portions correspond to at least one of a plurality of available levels of detail within the data structure.

An optional step 630 comprises controlling an interaction between the character and another element within the virtual environment in dependence upon the data access.

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

Embodiments of the present disclosure may be implemented in accordance with any one or more of the following numbered clauses:
1. A system for performing a selective data access for a character in a virtual environment, the system comprising:
   a data structure identification unit configured to identify a data structure to be accessed, the data structure comprising data regarding the virtual environment in which the character is present and/or one or more skills which are able to be utilized by that character;
   a parameter identification unit configured to identify one or more parameters associated with the character; and
   a data access unit configured to access one or more portions of the data structure in dependence upon the identified parameters, wherein the one or more portions correspond to at least one of a plurality of available levels of detail within the data structure.
2. A system according to clause 1, wherein the data structure comprises a hierarchical arrangement of data configured such that each hierarchical level corresponds to a different level of detail.
3. A system according to any preceding clause, wherein one or more of portions of the data structure respectively correspond to data of an entire level of detail.
4. A system according to any preceding clause, wherein one or more portions of the data structure respectively correspond to a subset of the data for a given level of detail.
5. A system according to clause 4, wherein the data access unit is configured to access two or more portions of the data structure which together correspond to a subset of data for each of two or more respective levels of detail.
6. A system according to clauses 4 or 5, wherein information associated with the data structure indicates one or more dependencies between portions of the data comprised by the data structure.
7. A system according to any preceding clause, wherein the parameters associated with a character include one or more of text descriptions, an event or action log, skill levels, accessible levels of detail for the data structure, and/or information indicating a history of access to the data structure by that character.
8. A system according to any preceding clause, wherein the data access unit is configured to input the one or more parameters into an algorithm to determine one or more access parameters, wherein the access parameters are used instead of the identified parameters to access the data structure.
9. A system according to any preceding clause, wherein the data access unit is configured to incorporate a random element into the data access for a character such that identical identified parameters correspond to non-identical data accesses.
10. A system according to any preceding clause, wherein the data access unit is configured to store data describing the accessed portions of the data structure for a character, and wherein this data is used for future data accesses of that data structure by that character.
11. A system according to any preceding clause, comprising an interaction unit which is configured to control an interaction between the character and another element within the virtual environment in dependence upon the data access.
12. A system according to clause 12, wherein the interaction is a conversation between the character and a player character associated with the player of a game comprising the virtual environment.
13. A method for performing a selective data access for a character in a virtual environment, the method comprising:
   identifying a data structure to be accessed, the data structure comprising data regarding the virtual environment in which the character is present and/or one or more skills which are able to be utilized by that character;
   identifying one or more parameters associated with the character; and
   accessing one or more portions of the data structure in dependence upon the identified parameters, wherein the one or more portions correspond to at least one of a plurality of available levels of detail within the data structure.
14. Computer software comprising instructions which, when the software is executed by a computer, causes the computer to carry out the method of clause 13.
15. A non-transitory machine-readable storage medium which stores computer software according to clause 14.

What is claimed is:

1. A system for performing a selective data access for a character in a virtual environment, the system comprising:
a data structure identification unit configured to identify a data structure to be accessed, the data structure comprising data regarding the virtual environment in which the character is present and/or one or more skills which are able to be utilized by that character;
a parameter identification unit configured to identify one or more parameters associated with the character; and
a data access unit configured to access one or more portions of the data structure in dependence upon the identified parameters, wherein the one or more portions correspond to at least one of a plurality of available levels of detail within the data structure.

2. The system of claim 1, wherein the data structure comprises a hierarchical arrangement of data configured such that each hierarchical level corresponds to a different level of detail.

3. The system of claim 1, wherein one or more of portions of the data structure respectively correspond to data of an entire level of detail.

4. The system of claim 1, wherein one or more portions of the data structure respectively correspond to a subset of the data for a given level of detail.

5. The system of claim 4, wherein the data access unit is configured to access two or more portions of the data structure which together correspond to a subset of data for each of two or more respective levels of detail.

6. A system according to claim 4, wherein information associated with the data structure indicates one or more dependencies between portions of the data comprised by the data structure.

7. The system of claim 1, wherein the parameters associated with a character include one or more of text descriptions, an event or action log, skill levels, accessible levels of detail for the data structure, and/or information indicating a history of access to the data structure by that character.

8. The system of claim 1, wherein the data access unit is configured to input the one or more parameters into an algorithm to determine one or more access parameters, wherein the access parameters are used instead of the identified parameters to access the data structure.

9. The system of claim 1, wherein the data access unit is configured to incorporate a random element into the data access for a character such that identical identified parameters correspond to non-identical data accesses.

10. The system of claim 1, wherein the data access unit is configured to store data describing the accessed portions of the data structure for a character, and wherein this data is used for future data accesses of that data structure by that character.

11. The system of claim 1, comprising an interaction unit which is configured to control an interaction between the character and another element within the virtual environment in dependence upon the data access.

12. The system of claim 11, wherein the interaction is a conversation between the character and a player character associated with the player of a game comprising the virtual environment.

13. A method for performing a selective data access for a character in a virtual environment, the method comprising:
identifying a data structure to be accessed, the data structure comprising data regarding the virtual environment in which the character is present and/or one or more skills which are able to be utilized by that character;
identifying one or more parameters associated with the character; and
accessing one or more portions of the data structure in dependence upon the identified parameters, wherein the one or more portions correspond to at least one of a plurality of available levels of detail within the data structure.

14. A non-transitory machine-readable storage medium which stores computer software which, when executed by a computer, causes the computer to perform a method for performing a selective data access for a character in a virtual environment, the method comprising:
identifying a data structure to be accessed, the data structure comprising data regarding the virtual environment in which the character is present and/or one or more skills which are able to be utilized by that character;
identifying one or more parameters associated with the character; and
accessing one or more portions of the data structure in dependence upon the identified parameters, wherein the one or more portions correspond to at least one of a plurality of available levels of detail within the data structure.
